(19) United States
(12) Patent Application Publication
(10) Pub. No.: US 2015/0331623 A1
(43) Pub. Date: Nov. 19, 2015

(54) METHOD AND APPARATUS FOR USING A DEFECTIVE DYNAMIC READ-ONLY MEMORY REGION

(71) Applicant: QUALCOMM Incorporated, San Diego, CA (US)

(72) Inventor: Xiangyu DONG, San Diego, CA (US)

(73) Assignee: QUALCOMM Incorporated, San Diego, CA (US)

(21) Appl. No.: 14/280,006

(22) Filed: May 16, 2014

(51) Int. Cl. G06F 3/06; G06F 11/07

(52) U.S. Cl. CPC G06F 3/0619; G06F 11/073; G06F 11/0787; G06F 3/064; G06F 3/0673

(57) ABSTRACT

Methods and apparatus for using a defective dynamic read-only memory region are provided. In an example, a defective Dynamic Random Access Memory (DRAM) page is used, instead of being disabled. A compress-and-store technique uses a non-defective region of a defective DRAM page to store page-swapping data. This allows the defective DRAM page to be used as a fast swapping resource, which results in increasing system performance, saving materials, saving time, and saving energy. In an example, a method for using a defective DRAM page in a DRAM includes using an error history table to determine that the defective DRAM page has a defective block, and updating a defect table with an address of the defective block. The defect table is used to determine an address of a good block in the defective DRAM page. Page swap data is compressed and stored in the good block in the defective DRAM page.

### FIELD OF DISCLOSURE

This disclosure relates generally to electronics, and more specifically, but not exclusively, to methods and apparatus that use a defective dynamic read-only memory region.

### BACKGROUND

Random access memory (RAM) is a ubiquitous component of modern digital circuit architectures. RAM can be a standalone device, or can be integrated in a device that uses the RAM, such as a microprocessor, microcontroller, application specific integrated circuit (ASIC), system-on-chip (SoC), and other like devices. One type of RAM is Dynamic Random Access Memory (DRAM). DRAM is a simple device that stores a data bit as a charge in a capacitor. DRAM's simplicity makes DRAM inexpensive and amenable to high density integration in memory arrays and embedded systems. Thus, DRAM is commonly-used in electronic devices.

As process nodes (i.e., an integrated circuit's minimum feature size) continues to shrink to sizes smaller than 20 nanometers, it is anticipated that DRAM circuits will likely have a higher percentage of defective regions in the smaller process nodes. The higher percentage of defective regions is due to larger variations in device structures which yield larger variations in DRAM retention time. A larger number of defective chips is anticipated due to more DRAM cells being integrated in each chip. Repairing the defective regions is expensive, so conventional techniques call for an entire defective DRAM page to be disabled (e.g., a 4 kilobyte page) even though only a portion (e.g., 64 bytes) of the defective page is defective. Conventional techniques also call for more frequent DRAM refreshing, which reduces system performance. Another typical technique is to increase DRAM redundancy, which increases system size, complexity, and cost. The conventional techniques reduce system performance, waste materials, waste time, and waste energy.

Accordingly, there are long-felt industry needs for methods and apparatus that improve upon conventional methods and apparatus, including the improved methods and apparatus provided hereby.

### SUMMARY

This summary provides a basic understanding of some aspects of the present teachings.

This summary is not exhaustive in detail, and is neither intended to identify all critical features, nor intended to limit the scope of the claims.

Exemplary methods and apparatus for using a defective Dynamic Random Access Memory (DRAM) page in a DRAM are provided. An exemplary method includes using an error history table to determine that the defective DRAM page has a defective block, updating a defect table with an address of the defective block, using the defect table to determine an address of a good block in the defective DRAM page, compressing page swap data, and storing the compressed page swap data in the good block in the defective DRAM page. The method can also include receiving a list of single-bit errors in the defective DRAM page and updating the error history table with the list of single-bit errors. The method can also include querying at least one of a memory controller and the DRAM for the list of single-bit errors. Further, the method can include updating a page table with a page address of the defective DRAM page to indicate that the defective DRAM page is defective. Also, the method can include updating a page table with an indication that the defective DRAM page is mapped to an entry in the defect table.

In a further example, provided is a non-transitory computer-readable medium, comprising instructions stored thereon that, if executed by a processor, such as a special-purpose processor, cause the processor to execute at least a part of the aforementioned method. The non-transitory computer-readable medium can be integrated with a device, such as a mobile device, a music player, a video player, an entertainment unit, a navigation device, a communications device, a personal digital assistant (PDA), a fixed location data unit, and/or a computer.

In another example, provided is an apparatus configured to use a defective DRAM page in a DRAM. The apparatus includes a processor configured to use an error history table to determine that the defective DRAM page has a defective block, to update a defect table with an address of the defective block, to use the defect table to determine an address of a good block in the defective DRAM page, to compress page swap data, and to store the compressed page swap data in the good block in the defective DRAM page. The processor can also be configured to receive a list of single-bit errors in the defective DRAM page and to update the error history table with the list of single-bit errors. The processor can also be configured to query at least one of a memory controller and the DRAM for the list of single-bit errors. The processor can also be configured to update a page table with a page address of the defective DRAM page to indicate that the defective DRAM page is defective. The processor can also be configured to update a page table with an indication that the defective DRAM page is mapped to an entry in the defect table.

At least a part of the apparatus can be integrated on a semiconductor die. Further, at least a part of the apparatus can include a device, such as a mobile device, a base station, a set top box, a music player, a video player, an entertainment unit, a navigation device, a communications device, a personal digital assistant (PDA), a fixed location data unit, and/or a computer, with another part of the apparatus (e.g., the processor) being a constituent part of the device. In a further example, provided is a non-transitory computer-readable medium, comprising instructions stored thereon that, if executed by a lithographic device, cause the lithographic device to fabricate at least a part of the apparatus.

The foregoing broadly outlines some of the features and technical advantages of the present teachings in order that the detailed description and drawings can be better understood. Additional features and advantages are also described in the detailed description. The conception and disclosed embodiments can be readily utilized as a basis for modifying or designing other structures for carrying out the same purposes of the present teachings. Such equivalent constructions do not depart from the technology of the teachings as set forth in the claims. The inventive features that are characteristic of the teachings, together with further objects and advantages, are better understood from the detailed description and the accompanying figures. Each of the figures is provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an exemplary wireless communication network.

FIG. 2 depicts a functional block diagram of an exemplary user device.

FIG. 3 depicts a functional block diagram of an exemplary access point.

FIG. 4 depicts an exemplary overview of a storage technique using a defective Dynamic Random Access Memory (DRAM) region.

FIG. 5 depicts an exemplary comparison of a normal page versus a defective page.

FIG. 6 depicts exemplary mapping details.

FIG. 7 depicts an exemplary method for using a defective DRAM page.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

### Introduction

Methods and apparatus for using a defective dynamic read-only memory region are provided. In an example, a defective Dynamic Random Access Memory (DRAM) page is used, instead of being disabled. A compress-and-store technique uses a non-defective region of a defective DRAM page to store page-swapping data. This allows the defective DRAM page to be used as a fast swapping resource.

The exemplary apparatuses and methods disclosed herein advantageously address the long-felt industry needs, as well as other previously unidentified needs, and mitigate shortcomings of the conventional methods and apparatus. For example, an advantage provided by the disclosed apparatuses and methods herein is an improvement in system performance over conventional devices. Other advantages include saving materials, saving time, and saving energy.

Exemplary embodiments are disclosed in this application's text and drawings. Alternate embodiments can be devised without departing from the scope of the invention. Additionally, conventional elements of the current teachings may not be described in detail, or may be omitted, to avoid obscuring aspects of the current teachings.

As used herein, the term “exemplary” means “serving as an example, instance, or illustration.” Any embodiment described as “exemplary” is not necessarily to be construed as preferred or advantageous over other embodiments. Likewise, the term “embodiments of the invention” does not require that all embodiments of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element. Coupling and/or connection between the elements can be physical, logical, or a combination thereof. As employed herein, elements can be “connected” or “coupled” together, for example, by using one or more wires, cables, and/or printed electrical connections, as well as by using electromagnetic energy. The electromagnetic energy can have wavelengths in the radio frequency region, the microwave region and/or the optical (both visible and invisible) region. These are several non-limiting and non-exhaustive examples.

It should be understood that the term “signal” can include any signal such as a data signal, audio signal, video signal, multimedia signal, analog signal, and/or digital signal. Information and signals can be represented using any of a variety of different technologies and techniques. For example, data, an instruction, a process step, a command, information, a signal, a bit, and/or a symbol described in this description can be represented by a voltage, a current, an electromagnetic wave, a magnetic field and/or particle, an optical field and/or particle, and any combination thereof.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims can be interpreted as “A or B or C or any combination of these elements.”

The terminology used herein is for the purpose of describing particular embodiments only and is not intended to be limiting. As used herein, the singular forms “a,” “an,” and “the” are intended to include the plural forms as well, unless the context clearly indicates otherwise. Further, the terms “comprises,” “comprising,” “includes,” and “including,” when used herein, specify a presence of stated features, integers, steps, operations, elements, and/or components, but do not preclude the presence and/or addition of one or more other features, integers, steps, operations, elements, components, and/or groups thereof.

The provided apparatuses can be a part of and/or coupled to, an electronic device having a memory, such as, but not limited to, a mobile device, a mobile telephone, a wireless device, a personal data assistant (PDA), a hand-held computer, a portable computer, a GPS receiver, a navigation device, a camera, an audio player, a camcorder, a game console, a watch, a clock, a calculator, a television, a flat panel display, a computer monitor, an auto display (e.g., an odometer display, etc.), a cockpit control and/or display, a display coupled to a camera (e.g., a rear and/or side view camera in a vehicle), an electronic photograph frame, an electronic billboard, an electronic sign, and/or a projector.

The term “mobile device” can describe, and is not limited to, a mobile phone, a mobile communication device, a pager, a personal digital assistant, a personal information manager, a mobile hand-held computer, a portable computer, a wireless device, a wireless modem, and/or other types of portable electronic devices typically carried by a person and having communication capabilities (e.g., wireless, cellular, infrared, short-range radio, etc.). Further, the terms “user equipment” (UE), “mobile terminal,” “mobile device,” and “wireless device” can be interchangeable.

### DESCRIPTION OF THE FIGURES

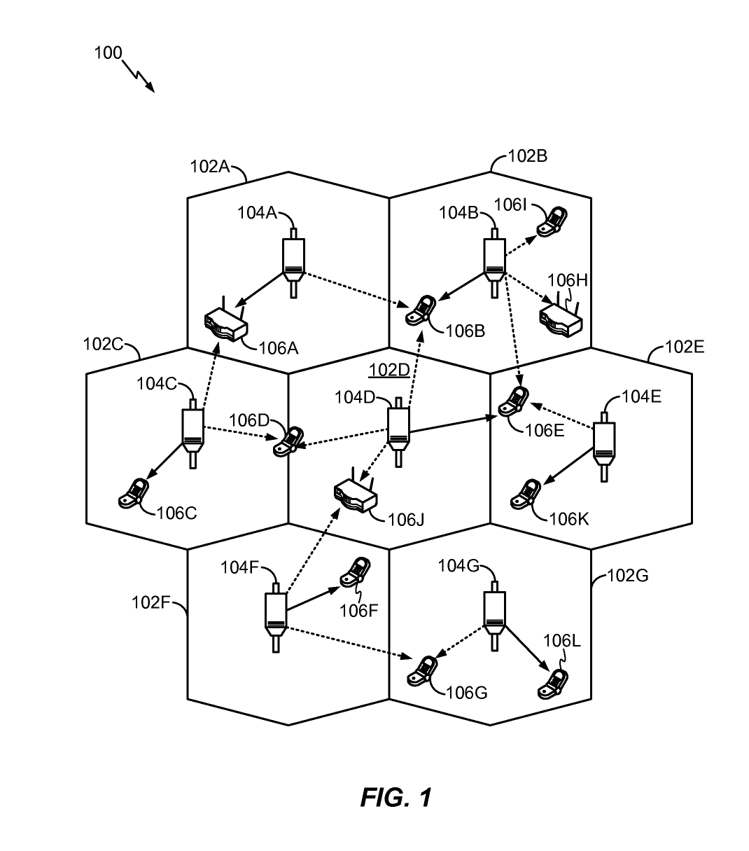

FIG. 1 depicts an exemplary wireless communication network 100 to demonstrate principles of multiple access communication. The wireless communication network 100 is configured to support communication between multiple users. As shown, the wireless communication network 100 can be divided into one or more cells 102A-102G. Communication coverage in cells 102A-102G can be provided by one or more access points 104A-104G. Thus, each of the access points 104A-104G can provide communication coverage to a corresponding cell 102A-102G. The access points 104A-104G can interact with at least one user device in a plurality of user devices 106A-106L.

Each user device 106A-106L can communicate with one or more of the access points 104A-104G on a downlink (DL) and/or an uplink (UL). In general, a DL is a communication link from an access point to a user device, while an UL is a communication link from a user device to an access point. The access points 104A-104G can be coupled via wired or wireless interfaces, allowing the access points 104A-104G to communicate with each other and/or other network equipment. Accordingly, each user device 106A-106L can also communicate with another user device 106A-106L via one or more of the access points 104A-104G. For example, the user device 106J can communicate with the user device 106H in the following manner the user device 106J can communicate with the access point 104D, the access point 104D can communicate with the access point 104B, and the access point 104B can communicate with the user device 106H, allowing communication to be established between the user device 106J and the user device 106H.

The wireless communication network 100 can provide service over a large geographic region, a small geographic region, and any size region having a size in between the large geographic region and the small geographic region. For example, the cells 102A-102G can cover a few blocks within a neighborhood or several square miles in a rural environment. In some systems, each of the cells 102A-102G can be further divided into one or more sectors (not shown). In addition, the access points 104A-104G can provide the user devices 106A-106L within their respective coverage areas (i.e., respective cells 102A-102G) with access to other communication networks, such as at least one of the Internet, a cellular network, a private network, and the like. In the example shown in FIG. 1, the user devices 106A, 106H, and 106J comprise routers, while the user devices 106B-106G, 1061, 106K, and 106L comprise mobile phones. However, each of the user devices 106A-106L can comprise any suitable communication device.

At least a portion of the apparatus and methods disclosed herein can be implemented in at least one of the access points 104A-104G and the user devices 106A-106L.

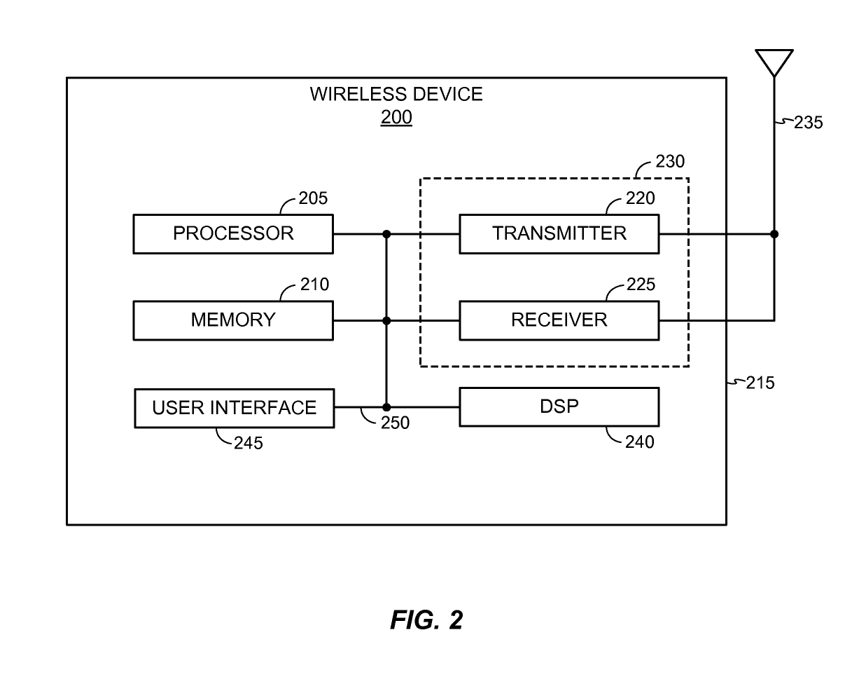

FIG. 2 depicts an exemplary functional block diagram of an exemplary user device 200, which can correspond to at least one of the user devices 106A-106L. FIG. 2 also depicts different components that can be implemented in the user device 200. The user device 200 is an example of a device that can be configured to include the apparatus described herein.

The user device 200 can include a processor 205 which is configured to control operation of the user device 200. The processor 205 can also be referred to as a central processing unit (CPU) and as a special-purpose processor. A memory 210, which can include at least one of read-only memory (ROM) and random access memory (RAM) (e.g., a DRAM) provides instructions and data to the processor 205. A portion of the memory 210 can include non-volatile random access memory (NVRAM). The processor 205 can perform logical and arithmetic operations based on program instructions stored within the memory 210. The instructions in the memory 210 can be executable to implement at least a part of a method described herein.

The processor 205 can comprise or be a component of a processing system implemented with one or more processors. The one or more processors can be implemented with a microprocessor, a microcontroller, a digital signal processor (DSP), a field programmable gate array (FPGA), a programmable logic device (PLD), a controller, a state machine, gated logic, a discrete hardware component, a dedicated hardware finite state machine, and/or any other suitable entity that can calculate and/or manipulate information.

The processing system can also include a non-transitory machine-readable media (e.g., the memory 210) that stores software. Software can mean any type of instructions, whether referred to as software, firmware, middleware, microcode, hardware description language, and/or otherwise. Instructions can include code (e.g., in source code format, binary code format, executable code format, or any other suitable format of code). The instructions, when executed by the processor 205, can transform the processor 205 into a special-purpose processor that causes the processor to perform a function described herein.

The user device 200 can also include a housing 215, a transmitter 220, and a receiver 225 to allow transmission and reception of data between the user device 200 and a remote location. The transmitter 220 and receiver 225 can be combined into a transceiver 230. An antenna 235 can be attached to the housing 215 and electrically coupled to the transceiver 230. The user device 200 can also include (not shown) multiple transmitters, multiple receivers, multiple transceivers, and/or multiple antennas.

The user device 200 can further comprise a digital signal processor (DSP) 240 that is configured to process data. The user device 200 can also further comprise a user interface 245. The user interface 245 can comprise a keypad, a microphone, a speaker, and/or a display. The user interface 245 can include any element and/or component that conveys information to a user of the user device 200 and/or receives input from the user.

The various components of the user device 200 can be coupled together by a bus system 250. The bus system 250 can include a data bus, for example, as well as a power bus, a control signal bus, and/or a status signal bus in addition to the data bus. Those of skill in the art will appreciate the components of the user device 200 can be coupled together to accept or provide inputs to each other using a different suitable mechanism.

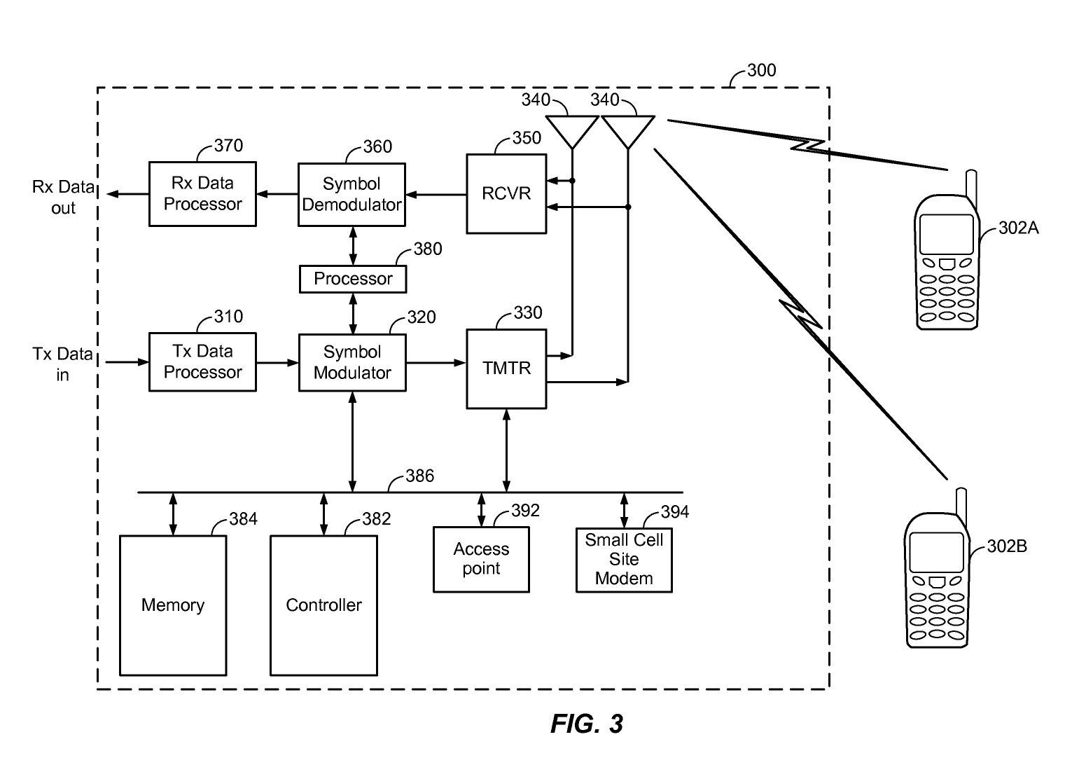

FIG. 3 depicts an exemplary access point 300. The access point 300 can correspond to any of the access points 104A-104G. As shown, the access point 300 includes a TX data processor 310, symbol modulator 320, transmitter unit (TMTR) 330, antenna(s) 340, receiver unit (RCVR) 350, symbol demodulator 360, RX data processor 370, and configuration information processor 380, performing various operations for communicating with one or more user devices 302A-302B. The user devices 302A-302B can correspond to at least one user device in a plurality of user devices 106A-106L. The access point 300 can also include a controller 382 and a memory 384 configured to store related data or instructions. Together, via a bus 386, these units can perform special-purpose processing in accordance with the appropriate radio technology or technologies used for communication, as well as other functions for the access point 300.

The controller 382 is configured to control operation of the access point 300. The controller 382 can also be referred to as a central processing unit (CPU) and as a special-purpose processor. The memory 384, which can include at least one of read-only memory (ROM) and random access memory (RAM) (e.g., a DRAM) provides instructions and data to the controller 382. A portion of the memory 384 can include non-volatile random access memory (NVRAM). The controller 382 can perform logical and arithmetic operations based on program instructions stored within the memory 384. The instructions in the memory 384 can be executable to implement at least a part of a method described herein.

The controller 382 can comprise or be a component of a processing system implemented with one or more processors. The one or more processors can be implemented with a microprocessor, a microcontroller, a digital signal processor (DSP), a field programmable gate array (FPGA), a programmable logic device (PLD), a controller, a state machine, gated logic, a discrete hardware component, a dedicated hardware finite state machine, and/or any other suitable entity that can manipulate information.

The processing system can also include a non-transitory machine-readable media (e.g., the memory 384) that stores software. Software can mean any type of instructions, whether referred to as software, firmware, middleware, microcode, hardware description language, and/or otherwise. Instructions can include code (e.g., in source code format, binary code format, executable code format, or any other suitable format of code). The instructions, when executed by the controller 382, can transform the controller 382 into a special-purpose processor that causes the processor to perform a function described herein.

The access point 300 can include at least one of a wireless local area network (WLAN) air interface (e.g., in accordance with an IEEE 802.11x protocol) and a cellular air interface (e.g., in accordance with an LTE protocol). As shown, the access point 300 includes an 802.11x access point (AP) 392 co-located with a small site modem (FSM) 394, such as a femtocell station modem. The functionality of one or more of these components can be integrated directly into, or otherwise performed by, the controller 382 of the access point 300, sometimes in conjunction with the memory 384.

The access point 300 can communicate with the user devices 302A-302B via the AP 392 and/or the FSM 394. A single user device (e.g., the user device 302A) can communicate with the access point 300 via both the AP 392 and the FSM 394, either simultaneously or at different times.

In general, the AP 392 can provide an air interface (e.g., in accordance with an IEEE 802.11x protocol) over an unlicensed portion of the wireless spectrum such as an industrial, scientific, and medical (ISM) radio band, whereas the FSM 394 can provide an air interface (e.g., in accordance with an LTE protocol) over a licensed portion of the wireless band reserved for cellular communications. However, the FSM 394 can also be configured to provide cellular (e.g., LTE) connectivity over an unlicensed portion of the wireless spectrum. This type of unlicensed cellular operation can include the use of an anchor licensed carrier operating in a licensed portion of the wireless spectrum (e.g., LTE Supplemental DownLink (SDL)) and an unlicensed portion of the wireless spectrum (e.g., LTE/LTE Advanced in unlicensed spectrum), or can be a standalone configuration operating without using an anchor licensed carrier (e.g., LTE Standalone).

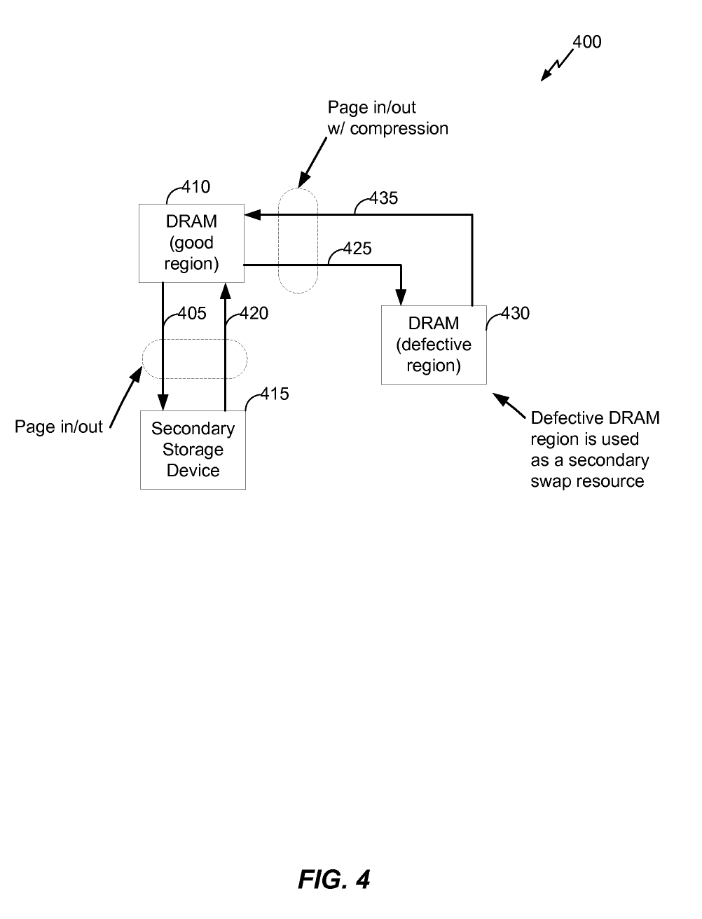

FIG. 4 depicts an exemplary overview of a storage technique 400 using a defective DRAM region. A “page swap” is a technique used in virtual memory management in which rarely-used pages are “paged out” 405 (i.e., transferred) from a main memory 410 having a short access time (e.g., DRAM, cache memory), and stored in a secondary storage device 415 having a longer access time (e.g., a hard disk drive). When the page is needed, the page is “paged in” 420 (i.e., transferred) from the secondary storage device 415 to the main memory 410. The page swap improves system performance by freeing seldom-accessed space in the main memory 410.

FIG. 4 also depicts storing a compressed page in a good block of a defective region of the main memory 410. An error-code correcting memory (EEC) detects that a DRAM block has a defective region (i.e., a defective block) 430, such as a 64Byte block. A DRAM (or memory controller (MEMCTRL)) can report at least one of a single-bit error and a double-bit error using ECC. The EEC can be in-DRAM or an in-system ECC. The DRAM (or the MEMCTRL) can track an occurrence of the at least one of the single-bit error and the double-bit error occurrence and store data describing the occurrence in a register (either volatile or non-volatile). The DRAM (or the MEMCTRL) can also track a location of the at least one of the single-bit error and the double-bit error occurrence and store data describing the location in a register (either volatile or non-volatile).

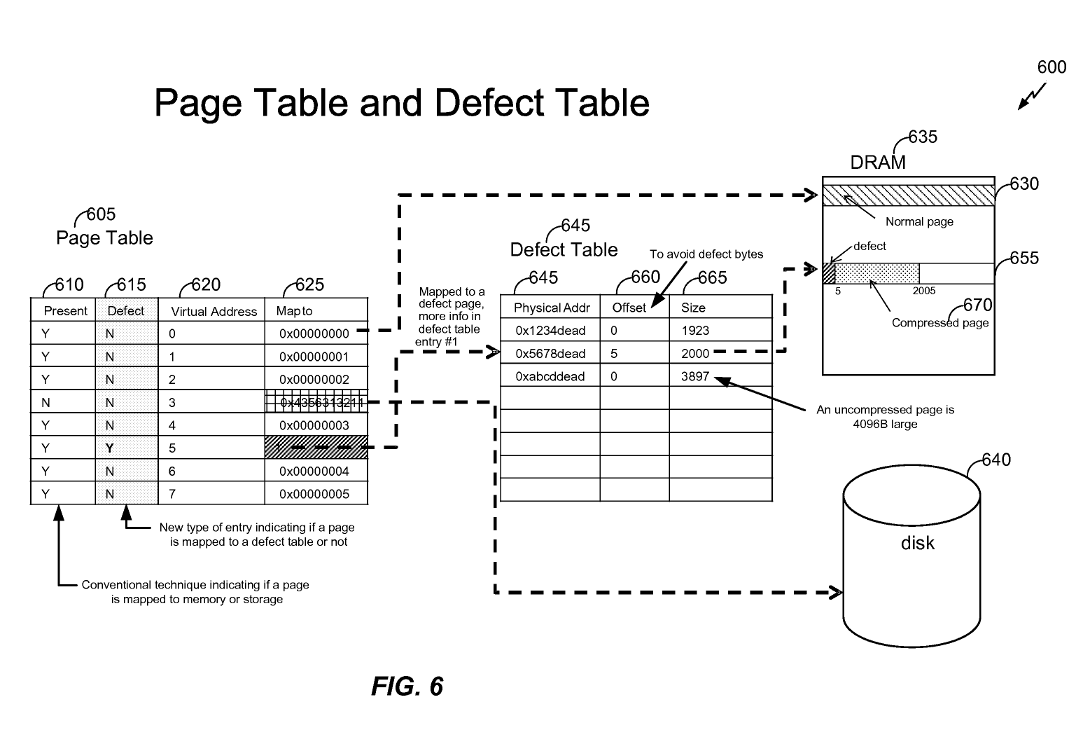

During normal operation, the operating system (OS) queries the DRAM (or the MEMCTRL) to obtain a list of newly-discovered single-bit error occurrences and locations from the DRAM (or the MEMCTRL) register. The OS accumulates the single-bit error information in an error history table. Upon a double error event, the OS queries the DRAM (or MEMCTRL) to retrieve the double-bit error location from the DRAM (or the MEMCTRL) register before entering a system crash process. The OS accumulates the double-bit error information in the error history table. After each error history table update, the OS determines, based on a predefined threshold, which page is likely to have a permanent error bit, and the OS marks the corresponding OS page including the defective region 430 as a “defective page.” The OS avoids using the defective region 430 for normal use. Instead, the OS uses the good block of the defective region 430 to perform a page swap. In other words, the good block of the defective region 430 is used as a swap cache. A compressed page is paged out 425 from a non-defective (i.e., good) region of the main memory 410 to the defective region 430 of the main memory 410. The page out 425 process can include compressing the page-out data, finding the good block of the defective region 430 that is of a size that can store the compressed page-out data, storing the compressed page-out data in the good block of the defective region 430, and updating an OS page table (e.g., a defect table—See FIG. 6) to indicate the new location of the compressed page-out data.

When the page is needed, the compressed page is paged in 435 from the good block of the defective region 430 of the main memory 410 to the non-defective (i.e., good) region of the main memory 410. The page in process includes the OS finding a location of the compressed page in a look-up OS page table, decompressing the compressed page, and loading the decompressed page into the main memory 410.

During OS shutdown, the OS stores the defect table in a permanent storage device (e.g., the secondary storage device 415, a system disk, a dedicated ROM). The OS can also store an error history table into the permanent storage device.

During OS boot-up, a bootloader loads the defect table from the permanent storage device. The bootloader determines if a default kernel image loading position is error-free. For example, a Linux kernel is loaded from a 1 MB-4 MB physical address space by default. If the default loading address is not error free, the bootloader selects a new position to load the OS kernel. Then, the OS loads the defect table from the permanent storage device. The OS can remove entries for defective pages from a free page list, and avoid using the defective pages during virtual-to-physical mapping.

When compared to swapping a page with the secondary storage device 415, performing the storage technique 400 to compress and swap with the defective region 430 is faster.

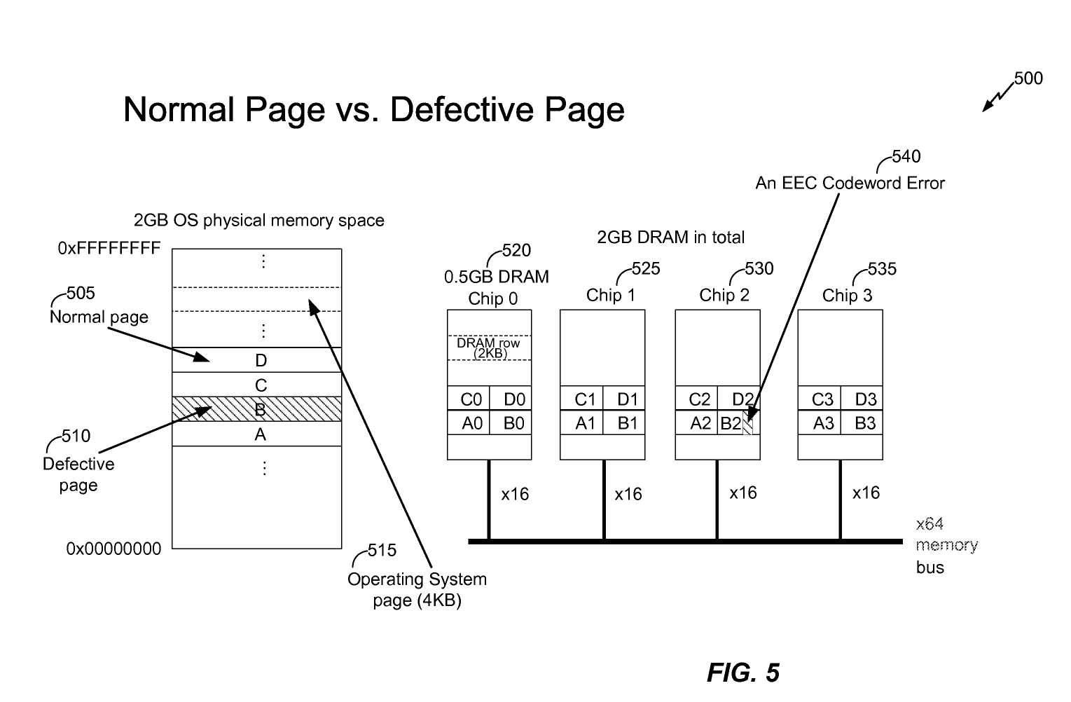

FIG. 5 depicts an exemplary comparison 500 of a normal page 505 versus a defective page 510. FIG. 5 depicts a memory map 515 having operating system pages (e.g., 4 KB pages) including pages A, B, C, and D. Operating system page D is a normal page 505 and operating system page B is a defective page 510. The memory map 515 covers a range of the OS's physical memory space. In the example of FIG. 5, the range is an exemplary 2 GB, however in practice, the OS's physical memory space can be any practicable quantity. Entries in the memory map 515 correspond to physical locations in a DRAM, which in the example of FIG. 5 is comprised of four 0.5 GB DRAM memory chips 520, 525, 530, and 535. Although four 0.5 GB DRAM memory chips are depicted and described in this example, in practice any other practicable number of memory chips can be used, any other practicable memory chip storage capacity can be used, and the total memory capacity can be any practicable amount. Further, in practice any practicable memory addressing scheme can be used.

A portion of each of the normal page 505 D is stored in a respective portion of the four 0.5 GB DRAM memory chips 520, 525, 530, and 535 as D1, D2, D3, and D4. In contrast, a portion of the defective page 510 B is stored in a respective portion of the four 0.5 GB DRAM memory chips 520, 525, 530, and 535 as B1, B2, B3, and B4. An EEC codeword error 540 is shown in memory 530 in location B2 as a shaded portion of B2. The defective portion of the memory chip 530 is the cause of the defective page 510 B being defective.

FIG. 6 depicts exemplary mapping details 600. An OS page table 605 includes data describing details about pages used by the OS. The data can include an indication that a page is present 610 in the page table 605, an indication that the page is defective 615, a virtual address 620 for the page, and an address 625 to which the page is mapped.

The address 625 can indicate that the page (e.g., a present and non-defective page such as the page depicted as having virtual address “1”) is mapped to a normal page 630 in a DRAM 635.

The address 625 can alternatively indicate that the page (e.g., a not present and non-defective page such as the page depicted as having virtual address “3”) is mapped to a secondary storage device 640 having a longer access time (e.g., the secondary storage device 415, a hard disk drive, and the like).

The address 625 can alternatively indicate that the page (e.g., a present and defective page such as the page depicted as having virtual address “5”) is mapped to an entry in a defect table 645. The defect table 645 includes data describing details about defective pages. The data can include a physical address 650 of a defective page 655 in the DRAM 635, an offset number of bytes 660 to avoid storing data in defective bytes (e.g., a defective block) in the DRAM 635, and a size 665 of a usable non-defective region in the defective page.

In the example, in FIG. 5, the defective page 655 has a defective region in the first five bytes, thus the respective offset number of bytes 660 is five. The defective page 655 has a usable non-defective region with a size 665 of 2000 bytes and an address from 5 to 2005. The usable non-defective region of the defective page 655 can be used to store a compressed page 670 having a size of 2000 bytes or less.

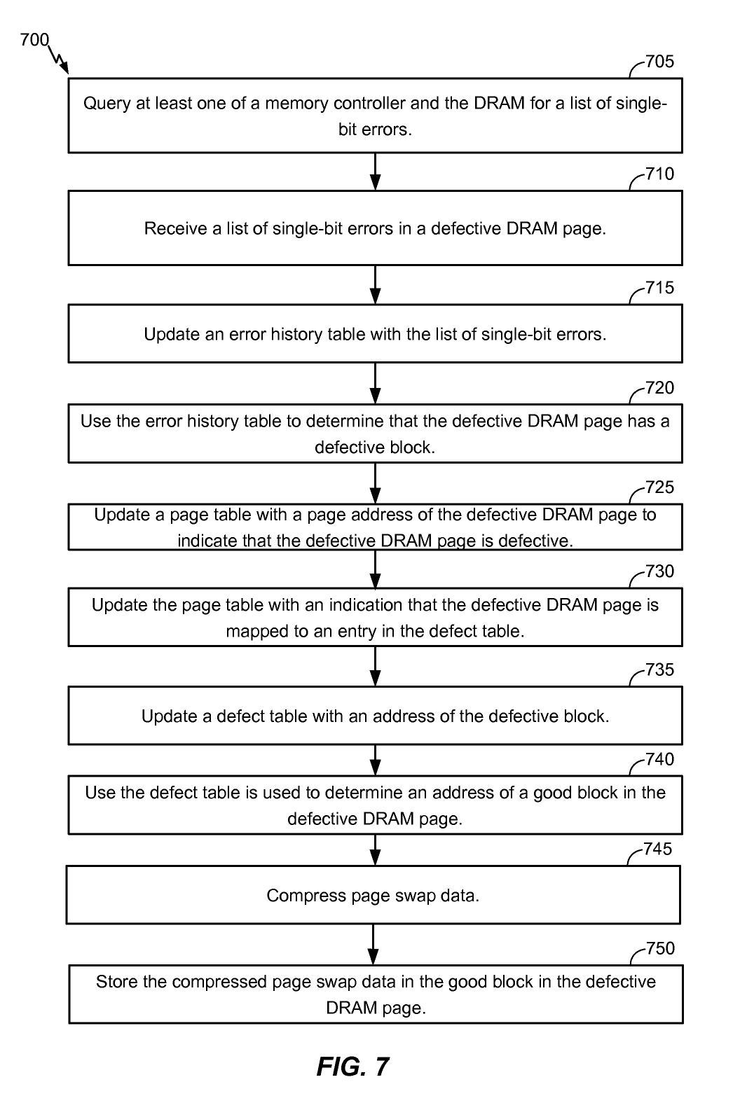

FIG. 7 depicts an exemplary method for using a defective Dynamic Random Access Memory (DRAM) page in a DRAM 700. The method for using a defective Dynamic Random Access Memory (DRAM) page in a DRAM 700 can be performed by the apparatus described hereby, such as at least one of the access points 104A-104G and the user devices 106A-106L.

In step 705, at least one of a memory controller and the DRAM is queried for a list of single-bit errors.

In step 710, a list of single-bit errors in a defective DRAM page is received.

In step 715, an error history table is updated with the list of single-bit errors.

In step 720, the error history table is used to determine that the defective DRAM page has a defective block.

In step 725, a page table is updated with a page address of the defective DRAM page. This can indicate that the defective DRAM page is defective.

In step 730, the page table is updated with an indication that the defective DRAM page is mapped to an entry in the defect table.

In step 735, a defect table is updated with an address of the defective block.

In step 740, the defect table is used to determine an address of a good block in the defective DRAM page.

In step 745, page swap data is compressed.

In step 750, the compressed page swap data is stored in the good block in the defective DRAM page.

The foregoing steps are not limiting of the various embodiments. The steps can be combined and/or the order rearranged to implement the depicted and described techniques.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In some aspects, the teachings herein can be employed in a multiple-access system capable of supporting communication with multiple users by sharing the available system resources (e.g., by specifying one or more of bandwidth, transmit power, coding, interleaving, and so on). For example, the teachings herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure can be described using 3GPP terminology, it is to be understood that the teachings herein can be applied to 3GPP (e.g., Re199, Re15, Re16, Re17) technology, as well as 3GPP2 (e.g., 1xRTT, 1xEV-DO Re10, RevA, RevB) technology and other technologies. The techniques can be used in emerging and future networks and interfaces, including Long Term Evolution (LTE).

At least a portion of the methods, sequences, and/or algorithms described in connection with the embodiments disclosed herein can be embodied directly in hardware, in software executed by a processor, or in a combination of the two. In an example, a processor includes multiple discrete hardware components. A software module may reside in RAM memory, flash memory, ROM memory, EPROM memory, EEPROM memory, registers, hard disk, a removable disk, a CD-ROM, and/or any other form of storage medium known in the art. An exemplary storage medium (e.g., a memory) can be coupled to the processor such that the processor can read information from, and write information to, the storage medium. In an alternative, the storage medium may be integral with the processor.

Further, many embodiments are described in terms of sequences of actions to be performed by, for example, elements of a computing device. The actions described herein can be performed by a specific circuit (e.g., an application specific integrated circuit (ASIC)), by program instructions being executed by one or more processors, or by a combination of both. Additionally, a sequence of actions described herein can be considered to be embodied entirely within any form of computer readable storage medium having stored therein a corresponding set of computer instructions that upon execution would cause an associated processor (such as a special-purpose processor) to perform at least a portion of a function described herein. Thus, the various aspects of the invention may be embodied in a number of different forms, all of which have been contemplated to be within the scope of the claimed subject matter. In addition, for each of the embodiments described herein, a corresponding circuit of any such embodiments may be described herein as, for example, “logic configured to” perform a described action.

An embodiment of the invention can include a computer readable media embodying a method described herein. Accordingly, the invention is not limited to illustrated examples and any means for performing the functions described herein are included in embodiments of the invention.

The disclosed devices and methods can be designed and can be configured into a computer-executable file that is in a Graphic Database System Two (GDSII) compatible format, an Open Artwork System Interchange Standard (OASIS) compatible format, and/or a GERBER (e.g., RS-274D, RS-274X, etc.) compatible format, which are stored on a non-transitory (i.e., a non-transient) computer-readable media. The file can be provided to a fabrication handler who fabricates with a lithographic device, based on the file, an integrated device. Deposition of a material to form at least a portion of a structure described herein can be performed using deposition techniques such as physical vapor deposition (PVD, e.g., sputtering), plasma-enhanced chemical vapor deposition (PECVD), thermal chemical vapor deposition (thermal CVD), and/or spin-coating. Etching of a material to form at least a portion of a structure described herein can be performed using etching techniques such as plasma etching. In an example, the integrated device is on a semiconductor wafer. The semiconductor wafer can be cut into a semiconductor die and packaged into a semiconductor chip. The semiconductor chip can be employed in a device described herein (e.g., a mobile device).

Embodiments can include a non-transitory (i.e., a non-transient) machine-readable media and/or a non-transitory (i.e., a non-transient) computer-readable media embodying instructions which, when executed by a processor (such as a special-purpose processor), transform a processor and any other cooperating devices into a machine (e.g., a special-purpose processor) configured to perform at least a part of a function described hereby and/or transform a processor and any other cooperating devices into at least a part of the apparatus described hereby.

Nothing stated or illustrated depicted in this application is intended to dedicate any component, step, feature, object, benefit, advantage, or equivalent to the public, regardless of whether the component, step, feature, object, benefit, advantage, or the equivalent is recited in the claims.

While this disclosure describes exemplary embodiments of the invention, it should be noted that various changes and modifications could be made herein without departing from the scope of the invention as defined by the appended claims.

What is claimed is:

1. A method for using a defective Dynamic Random Access Memory (DRAM) page in a DRAM, comprising:
using an error history table to determine that the defective DRAM page has a defective block;
updating a defect table with an address of the defective block;
using the defect table to determine an address of a good block in the defective DRAM page;
compressing page swap data; and
storing the compressed page swap data in the good block in the defective DRAM page.

2. The method of claim 1, further comprising:
receiving a list of single-bit errors in the defective DRAM page; and
updating the error history table with the list of single-bit errors.

3. The method of claim 2, further comprising querying at least one of a memory controller and the DRAM for the list of single-bit errors.

4. The method of claim 1, further comprising updating a page table with a page address of the defective DRAM page to indicate that the defective DRAM page is defective.

5. The method of claim 1, further comprising updating a page table with an indication that the defective DRAM page is mapped to an entry in the defect table.

6. An apparatus configured to use a defective Dynamic Random Access Memory (DRAM) page in a DRAM, comprising:
a processor configured to:
use an error history table to determine that the defective DRAM page has a defective block;
update a defect table with an address of the defective block;
use the defect table to determine an address of a good block in the defective DRAM page;
compress page swap data; and
store the compressed page swap data in the good block in the defective DRAM page.

7. The apparatus of claim 6, wherein the processor is further configured to:
receive a list of single-bit errors in the defective DRAM page; and
update the error history table with the list of single-bit errors.

8. The apparatus of claim 7, wherein the processor is further configured to query at least one of a memory controller and the DRAM for the list of single-bit errors.

9. The apparatus of claim 6, wherein the processor is further configured to update a page table with a page address of the defective DRAM page to indicate that the defective DRAM page is defective.

10. The apparatus of claim 6, wherein the processor is further configured to update a page table with an indication that the defective DRAM page is mapped to an entry in the defect table.

11. The apparatus of claim 6, wherein at least a part of the processor is integrated on a semiconductor die.

12. The apparatus of claim 6, further comprising at least one of a mobile device, a base station, a terminal, a set top box, a music player, a video player, an entertainment unit, a navigation device, a communications device, a personal digital assistant (PDA), a fixed location data unit, and a computer, of which the processor is a constituent part.

13. A non-transitory computer-readable medium, comprising processor-executable instructions stored thereon configured to cause a processor to execute a method comprising:
using an error history table to determine that the defective DRAM page has a defective block;
updating a defect table with an address of the defective block;
using the defect table to determine an address of a good block in the defective DRAM page;
compressing page swap data; and
storing the compressed page swap data in the good block in the defective DRAM page.

14. The non-transitory computer-readable medium of claim 13, wherein the method further comprises:
receiving a list of single-bit errors in the defective DRAM page; and
updating the error history table with the list of single-bit errors.

15. The non-transitory computer-readable medium of claim 14, wherein the method further comprises querying at least one of a memory controller and the DRAM for the list of single-bit errors.

16. The non-transitory computer-readable medium of claim 13, wherein the method further comprises updating a page table with a page address of the defective DRAM page to indicate that the defective DRAM page is defective.

17. The non-transitory computer-readable medium of claim 13, wherein the method further comprises updating a page table with an indication that the defective DRAM page is mapped to an entry in the defect table.
